(19) United States
(12) Patent Application Publication
(10) Pub. No.: US 2015/0234607 A1
(43) Pub. Date: Aug. 20, 2015

(54) DISK DRIVE AND DATA SAVE METHOD

(71) Applicant: KABUSHIKI KAISHA TOSHIBA, Tokyo (JP)

(72) Inventors: Michihiko Umeda, Yokohama-shi (JP); Masakazu Kitahara, Kunitachi-shi (JP); Seiji Toda, Kawasaki-shi (JP); Yuusuke Izumizawa, Yokohama-shi (JP); Nobuhiro Sugawara, Yokohama-shi (JP)

(21) Appl. No.: 14/314,278

(22) Filed: Jun. 25, 2014

Related U.S. Application Data
(60) Provisional application No. 61/941,859, filed on Feb. 19, 2014.

(51) Int. Cl. G06F 3/06

(52) U.S. Cl. CPC G06F 3/0619; G06F 3/0679; G06F 3/065; G06F 3/0676; G06F 2003/0692; G06F 2206/1014

(57) ABSTRACT

According to one embodiment, a disk drive includes a data-save control unit configured to, when a decrease of power is detected, save data in a volatile memory to a non-volatile memory using a backup power source. The disk drive further includes a command processing unit configured to, when new data is stored in the volatile memory, when a data amount of unsaved data, which has not been saved in a disk media memory, exceeds a backup data amount that can be saved from the volatile memory to the non-volatile memory, save the unsaved data to the disk media memory.

### CROSS-REFERENCE TO RELATED APPLICATIONS

This application is based upon and claims the benefit of priority from U.S. Provisional Application No. 61/941,859, filed on Feb. 19, 2014; the entire contents of which are incorporated herein by reference.

### FIELD

Embodiments described herein relate generally to a disk drive and a data save method.

### BACKGROUND

In a magnetic disk drive, when a write cache function is available, user data may be lost due to power shutdown, because a backup function with respect to power shutdown is not supported. At the time of power shutdown, the magnetic disk drive utilizes a back electromotive force at the time of stopping a spindle motor, so that write cache data in a volatile memory can be saved in a non-volatile memory. However, when a backup time at the time of power shutdown is short, the magnetic disk drive cannot save sufficient write cache data with respect to a volatile memory size. In the magnetic disk drive, in order to ensure the write cache data, the amount of write cache data that can be saved in a non-volatile memory needs to be limited, and in this case, normal write cache performance of the magnetic disk drive cannot be exerted.

### BRIEF DESCRIPTION OF THE DRAWINGS

FIG. 1 is a diagram showing a configuration example of a magnetic disk drive according to a first embodiment;

FIG. 2 is a diagram showing a firmware configuration of the magnetic disk drive according to the first embodiment;

FIG. 3 is a diagram showing a configuration example of a command information table according to the first embodiment;

FIG. 4 is a diagram showing a configuration example of a cache table according to the first embodiment;

FIG. 5 is a flowchart showing a command receiving process and a storing process of write cache data;

FIG. 6 is a flowchart showing a process of saving write cache data in a volatile memory in disk media;

FIG. 7 is a diagram showing a saved-data storage top address and a saved-data storage last address in a media save area of disk media;

FIG. 8 is a flowchart showing a write operation to a disk media;

FIG. 9 is a flowchart showing a saving process from a volatile memory in a non-volatile memory;

FIG. 10 is a diagram showing a movement of data in a magnetic disk drive; and

FIG. 11 is a flowchart showing a restoring process of respective pieces of data from a non-volatile memory at the time of reclosing of power.

### DETAILED DESCRIPTION

In general, according to one embodiment, a disk drive includes a volatile memory, a non-volatile memory, and a disk media memory. The disk drive further includes a detection unit configured to detect a state of power supplied from outside, and a backup power source. The disk drive further includes a data-save control unit configured to save data stored in the volatile memory to the non-volatile memory using the backup power source when the detection unit detects a decrease of power. The disk drive unit further includes a command processing unit configured to, when an amount of unsaved data in the volatile memory, which has not been saved in the disk media memory, exceeds a backup data amount that can be saved from the volatile memory to the non-volatile memory, save the unsaved data to the disk media memory.

Exemplary embodiments of a disk drive will be explained below in detail with reference to the accompanying drawings. The present invention is not limited to the following embodiments.

### First Embodiment

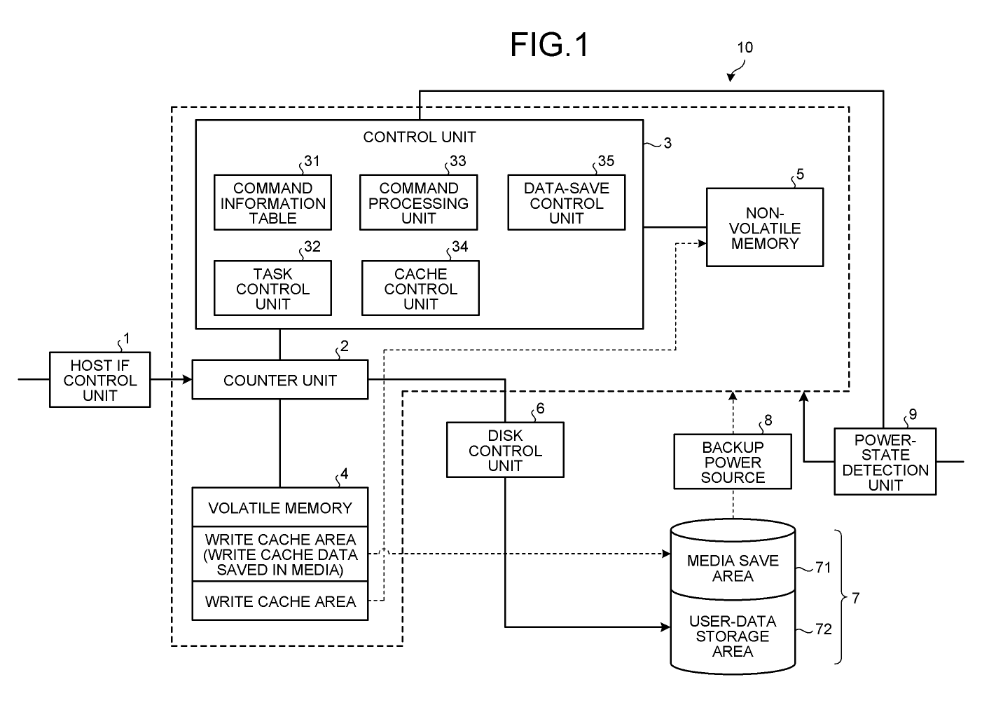

FIG. 1 is a diagram illustrating a configuration example of a magnetic disk drive according to the present embodiment. A magnetic disk drive 10, which is a disk drive, includes a host IF (Interface) control unit 1, a counter unit 2, a control unit 3, a volatile memory 4, a non-volatile memory 5, a disk control unit 6, disk media 7, a backup power source 8, and a power-state detection unit 9.

The control unit 3 includes a command information table 31, a task control unit 32, a command processing unit 33, a cache control unit 34, and a data-save control unit 35.

The host IF control unit 1 receives a command from an external host system and reports a completion status with respect to the received command to an external device.

The counter unit 2 monitors a data amount of write cache data on the volatile memory 4 being a cache memory.

In the magnetic disk drive 10, the control unit 3 manages command information and executes a command with respect to the command received from the host system, and executes control to save the write cache data stored in the volatile memory 4 in the non-volatile memory 5 or the disk media 7. The control unit 3 may be constituted by a microcomputer (MCU), a ROM (Read Only Memory), a RAM (Random Access Memory), and the like.

The command received from the host system is temporarily stored in the command information table 31. At this time, in the command information table 31, pieces of information such as a valid command flag, a command code, an access logical block address (LBA), the number of access blocks, a reported status flag, and used buffer information are held as command information for a plurality of commands, and the command information is set every time the command is received.

When a command is received in the command information table 31, the task control unit 32 extracts the command from the command information table 31 and activates the command processing unit 33. When a write command is received in the command information table 31, when a write cache function is available, the task control unit 32 decides a cache buffer area to be used when there is a free area in the cache buffer of the volatile memory 4 at the time of receiving the write command, and executes control to store data corresponding to the write command (write cache data) in the command information table 31 to the decided cache buffer area. At a time when storage of the data corresponding to the write command (write cache data) in the volatile memory 4 is complete, the task control unit 32 executes control to report a completion status to the host system via the host IF control unit 1. At this time, in the command information table 31, a reported status flag is set with respect to the command information.

When a plurality of commands is received in the command information table 31, upon completion of command processing that has been performed, the command processing unit 33 extracts a next command from the command information table 31 to start the command processing. During execution of the command, the task control unit 32 evaluates an access time, urgency of processing and the like, and decides which command is to be executed next by reordering. The command processing unit 33 activates the disk control unit 6 in the case of disk access. Upon completion of disk access, when a completion status has not been reported, the command processing unit 33 executes control to report the completion status to the host system via the host IF control unit 1, and invalidates the command information in the command information table 31 after completion of the command processing.

Because pieces of data indicated by a plurality of write commands (write cache data) can be stored in the volatile memory 4, the cache control unit 34 prepares cache control information for managing the write commands and holds the cache control information as a cache table. As the cache control information, pieces of information such as valid cache information flag, a write-start logical block address, a write data length (the number of access blocks), a write-data storage buffer address, a disk-media saved flag, and disk-media save destination address can be mentioned. In the cache table, a plurality of pieces of cache control information is prepared for each of the write cache data.

When the power-state detection unit 9 detects that power supplied from outside is cut or decreased to a level at which an operation of the magnetic disk drive 10 cannot be continued (hereinafter, “power shutdown”) by monitoring the state of power supplied from outside, the data-save control unit 35 uses the backup power source 8 to save the data in the volatile memory 4 in the non-volatile memory 5.

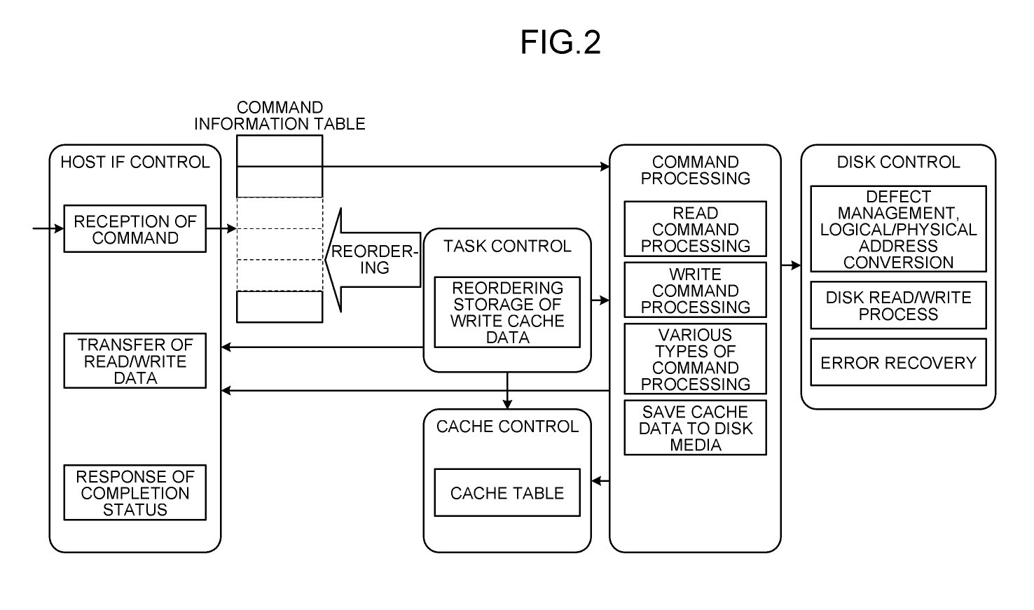

FIG. 2 is a diagram illustrating a firmware configuration of the magnetic disk drive according to the present embodiment. Host IF control shown in FIG. 2 represents processing contents of the host IF control unit 1 in FIG. 1, disk control shown in FIG. 2 represents processing contents of the disk control unit 6 in FIG. 1, and a command information table, task control, cache control, and command processing shown in FIG. 2 respectively represent processing contents of the control unit 3 in FIG. 1.

The host IF control includes respective processes such as reception of command, transfer of read/write data, and response of a completion status.

The task control includes respective processes such as reordering and storage of write cache data.

The command processing includes respective processes such as read command processing, write command processing, various types of command processing with respect to other commands, and save of the write cache data in the disk media.

The disk control includes respective processes such as defect management, logical/physical address conversion, disk read/write process, and error recovery.

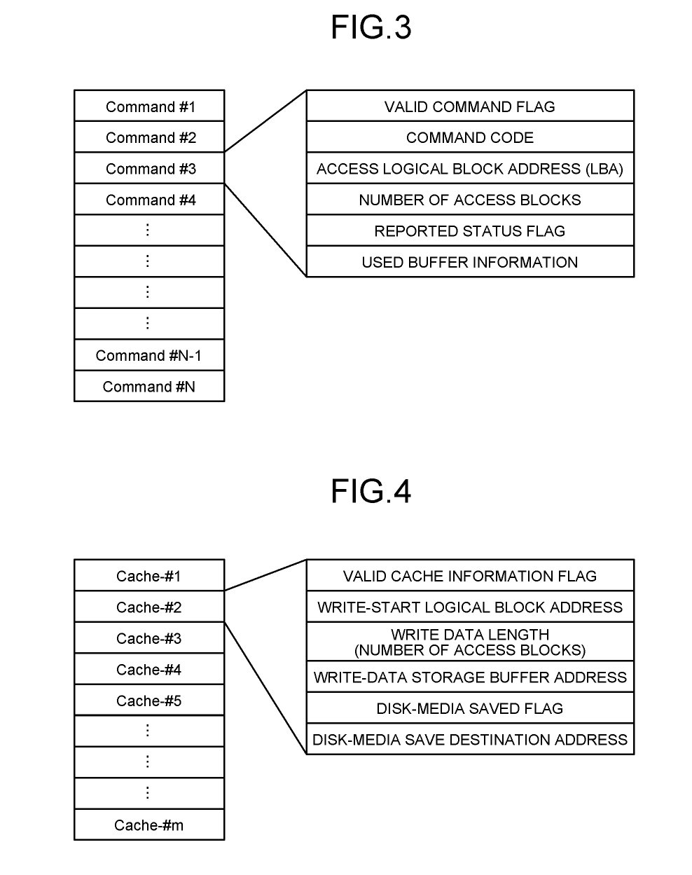

The command information table holds command information of received commands. FIG. 3 is a diagram illustrating a configuration example of the command information table according to the present embodiment. A command number is added and information such as the valid command flag and the command code described above is set for each received command.

The cache information holds the cache table of the write cache data stored in the volatile memory 4. FIG. 4 is a diagram illustrating a configuration example of the cache table according to the present embodiment. An entry number is added and information such as the valid cache information flag and the write-start logical block address described above is set for the stored write cache data.

The respective pieces of information in the command information table and the cache table are stored in the RAM constituting the control unit 3.

Referring back to FIG. 1, the volatile memory 4 stores therein data indicated by the write command (write cache data) received from the host system. The volatile memory 4 is a cache memory such as an SDRAM (Synchronous Dynamic Random Access Memory). The volatile memory 4 has a write cache area that can be saved in the non-volatile memory 5 and a write cache area having been saved in the disk media 7 as a cache buffer area. The size and storage position in the volatile memory 4 of the write cache area that can be saved in the non-volatile memory 5 and the write cache area having been saved in the disk media 7 vary according to a storage state and a save state of the write cache data at that time, and these areas are not a fixed area.

The non-volatile memory 5 is a save destination of the write cache data stored in the volatile memory 4 at the time of power shutdown.

The disk control unit 6 performs write processing and read processing of data with respect to the disk media 7.

The disk media 7 is a memory by disk media capable of performing write and read and includes, as a data storage area, a media save area 71 as an area being the save destination of the write cache data from the volatile memory 4, and a user-data storage area 72 as an area for storing therein data written by the normal command processing.

The backup power source 8 supplies power instead of the external power source at the time of power shutdown from outside. The backup power source 8 can supply power to the configuration in a frame of a dotted line shown in FIG. 1 (the counter unit 2, the control unit 3, the volatile memory 4, and the non-volatile memory 5).

The power-state detection unit 9 detects the state of power supplied from outside to the magnetic disk drive 10 and notifies the control unit 3 of the detected power state.

Subsequently, a process of saving the write cache data stored in the volatile memory 4 in the magnetic disk drive 10 is explained next. When the power-state detection unit 9 detects power shutdown, the magnetic disk drive 10 uses the backup power source 8 under control of the control unit 3, to save unsaved write cache data, which is stored in the volatile memory 4 and has not been saved in the disk media 7, in the non-volatile memory 5. The data size that can be saved in the non-volatile memory 5 at the time of power shutdown can be decided based on a backup power feeding time by the backup power source 8, a write time in the non-volatile memory 5, the use frequency of the non-volatile memory 5, and the temperature environment. The amount of write cache data that can be saved in the non-volatile memory 5 at the time of power shutdown is referred to as “PLP (Power Loss Protection) backup amount”.

In FIG. 1, a save destination is directly indicated such that the write cache data in the write cache area (saved in the media) of the volatile memory 4 is saved in the media save area 71 of the disk media 7, and the write cache data in the write cache area of the volatile memory 4 is saved in the non-volatile memory 5. This is for showing a transfer destination of the write cache data in a comprehensible manner. In practice, save of the write cache data is performed under control of the control unit 3.

A storing process of the write cache data and management of the write cache data is explained first.

In the magnetic disk drive 10, the counter unit 2 manages a data amount of the unsaved write cache data in the volatile memory 4 (hereinafter, “WC (Write Cache) size”), which has not been saved in the disk media 7. When a write command is received from the host system in the command information table 31, the task control unit 32 compares the WC size with the PLP backup amount. When the WC size does not exceed the PLP backup amount even if the write cache data indicated by a new write command is stored in the volatile memory 4, the task control unit 32 starts the storing process of the write cache data in the volatile memory 4. When the WC size exceeds the PLP backup amount when the write cache data indicated by the new write command is stored in the volatile memory 4, the task control unit 32 does not perform the storing process of the write cache data in the volatile memory 4, and the command processing unit 33 saves the write cache data in the volatile memory 4 in the disk media 7.

The task control unit 32 ensures a cache buffer area on the volatile memory 4 as a storing process of the write cache data, and performs control to store the data indicated by the write command (write cache data) in the volatile memory 4. At this time, the cache control unit 34 registers cache control information in the cache table. Upon completion of storage of the write cache data in the volatile memory 4, when the write cache setting is valid, the task control unit 32 performs control to report a completion status to the host system via the host IF control unit 1.

When the write cache data cannot be stored in the volatile memory 4, the task control unit 32 regularly refers to the command information table 31 and attempts to store the write cache data in the volatile memory 4 for the write cache data indicated by a write command that has not been stored in the volatile memory 4.

According to the processing described above, it is ensured that the WC size is equal to or smaller than the PLP backup amount, and the magnetic disk drive 10 can save data in the volatile memory 4 in the non-volatile memory 5 safely and reliably at the time of power shutdown.

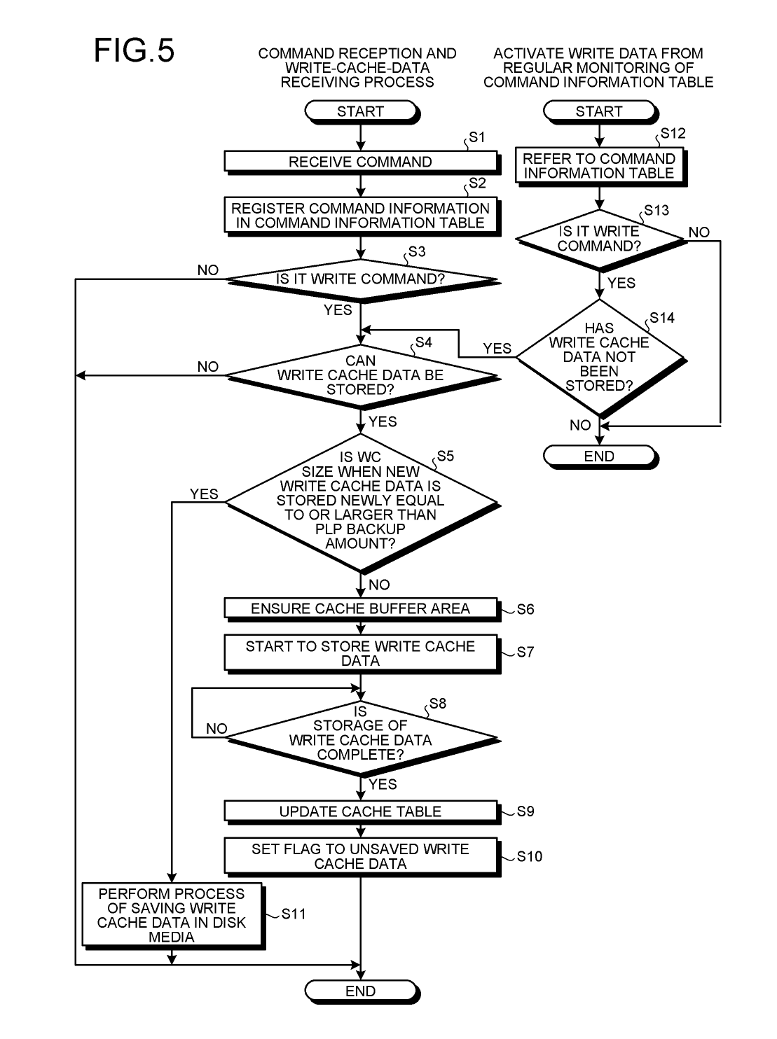

The operation of the magnetic disk drive 10 described above is explained based on a flowchart of FIG. 5. FIG. 5 is a flowchart illustrating a command receiving process and a storing process of write cache data. When the host IF control unit 1 receives a command from a higher-order device (Step S1), the magnetic disk drive 10 registers command information of the received command in the command information table 31 (Step S2). When the received command is not a write command (No at Step S3), the task control unit 32 finishes the process.

When the received command is a write command (Yes at Step S3), the task control unit 32 confirms whether the write cache data indicated by the write command can be stored in the volatile memory 4, that is, when there is a free space in the cache buffer and the cache table, and when the write cache data cannot be stored therein, finishes the process (No at Step S4).

When the write cache data can be stored (Yes at Step S4), the task control unit 32 confirms whether the WC size when the write cache data is newly stored in the volatile memory 4 is equal to or larger than the PLP backup amount. When the WC size is smaller than the PLP backup amount (No at Step S5), the task control unit 32 ensures the cache buffer area in the volatile memory 4 (Step S6), and starts to store the write cache data indicated by the write command in the volatile memory 4 (Step S7). The task control unit 32 continues the process until storage of the write cache data is complete (No at Step S8). When storage of the write cache data is complete (Yes at Step S8), the cache control unit 34 updates the cache table (Step S9), and sets a flag indicating that it is unsaved write cache data to the information of a disk-media saved flag in the cache control information (Step S10).

Referring back to Step S5, when the WC size is equal to or larger than the PLP backup amount (Yes at Step S5), the command processing unit 33 performs a process of saving the write cache data in the volatile memory 4 in the disk media 7 (Step S11).

The task control unit 32 regularly refers to the command information table 31 (Step S12), and when there is no write command information in the command information table 31, the task control unit 32 finishes the process (No at Step S13). When there is the write command information in the command information table 31 (Yes at Step S13), and when the write cache data indicated by the write command has been stored in the volatile memory 4, the task control unit 32 finishes the process (No at Step S14). When the write cache data indicated by the write command has not been stored in the volatile memory 4 (Yes at Step S14), the task control unit 32 performs the process at Step S4. Subsequent processes are the same as described above.

The process of saving the write cache data in the volatile memory 4 in the media save area 71 of the disk media 7 is explained next.

In the flowchart in FIG. 5, when the WC size at the time of newly storing the write cache data is equal to or larger than the PLP backup amount (No at Step S5), the command processing unit 33 performs the process of saving the write cache data in the volatile memory 4 in the disk media 7 (Step S11). Specifically, the command processing unit 33 refers to the disk-media saved flag on the cache table in the cache control unit 34, and saves the unsaved write cache data with the flag being cleared in the media save area 71 of the disk media 7.

The command processing unit 33 saves all the unsaved write cache data in the media save area 71 of the disk media 7. However, the present embodiment is not limited thereto, and with respect to only a part of the unsaved write cache data, the command processing unit 33 can save the unsaved write cache data when the WC size is slightly smaller than the PLP backup amount when the write cache data is newly stored. In this case, the number of processes to save the unsaved write cache data in the media save area 71 of the disk media 7 performed by the command processing unit 33 increases. However, because the unsaved write cache data to be saved in the media save area 71 of the disk media 7 is decreased, new write cache data can be stored in the volatile memory 4 quickly.

Upon completion of the process of saving the unsaved write cache data in the volatile memory 4 in the disk media 7, the command processing unit 33 updates the information of the disk-media saved flag and the disk-media save destination address, of the cache control information on the cache table.

The counter unit 2 subtracts the data amount of the unsaved write cache data having been saved in the disk media 7 from the WC size.

The magnetic disk drive 10 can decrease the WC size by saving the write cache data in the volatile memory 4 in the disk media 7, and can decrease the WC size when write cache data is newly stored less than the PLP backup amount. Therefore, new write cache data can be stored in the volatile memory 4. When the PLP backup amount is smaller than the size of the cache buffer of the volatile memory 4, the command processing unit 33 can ensure the WC size by saving the write cache data in the volatile memory 4 in the disk media 7 regularly, and thus can effectively use the write cache function.

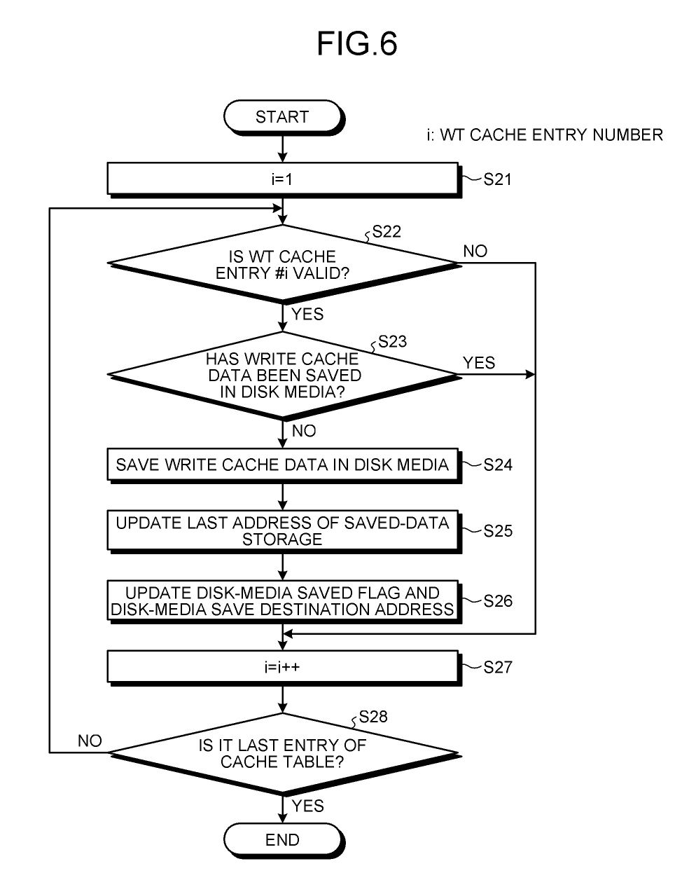

The operation of the magnetic disk drive 10 described above is explained with reference to a flowchart of FIG. 6. FIG. 6 is a flowchart illustrating a process of saving write cache data in a volatile memory in disk media.

In the magnetic disk drive 10, the command processing unit 33 refers to the cache table in the cache control unit 34 from a WT cache entry number 1 (Step S21). When the write cache data having the target WT cache entry number is valid (Yes at Step S22), the command processing unit 33 confirms whether the target write cache data in the volatile memory 4 has been saved in the disk media 7 based on the information of the disk-media saved flag of the cache control information (Step S23). When the target write cache data has not been saved in the disk media 7 (No at Step S23), the command processing unit 33 saves the target write cache data in the disk media 7 (Step S24). The command processing unit 33 updates a saved-data storage last address in the disk media 7 (Step S25), and updates the information of the disk-media saved flag and the disk-media save destination address in the cache table (Step S26). With respect to the next WT cache entry number (Step S27) in the cache table in the cache control unit 34, when the next WT cache entry number is not the last entry in the cache table (No at Step S28), the command processing unit 33 returns to Step S22 to perform the same process as described above.

When the write cache data having the target WT cache entry number is invalid (No at Step S22), and when the target write cache data has been saved in the disk media 7 (Yes at Step S23), the command processing unit 33 omits the process of saving the write cache data in the disk media 7 (Steps S24 to S26), and performs the process at Step S27.

With respect to the next WT cache entry number (Step S27) in the cache table in the cache control unit 34, when the next WT cache entry number is the last entry in the cache table (Yes at Step S28), the command processing unit 33 finishes the process.

A method of ensuring the media save area 71 in the disk media 7 is explained here. As shown in FIG. 1, in the disk media 7, it is assumed that a plurality of sectors is ensured at different positions from the user-data storage area 72 on the disk media as the media save area 71, to prepare a sufficiently large capacity with respect to the size of the write cache data beforehand. For example, when the capacity of the volatile memory 4 is 64 megabytes, it is assumed that the capacity of the media save area 71 of the disk media 7 is 512 megabytes.

The disk media 7 holds a saved-data storage top address and a saved-data storage last address with respect in the media save area 71. When the write cache data is saved from the volatile memory 4, the command processing unit 33 updates the saved-data storage last address of the disk media 7.

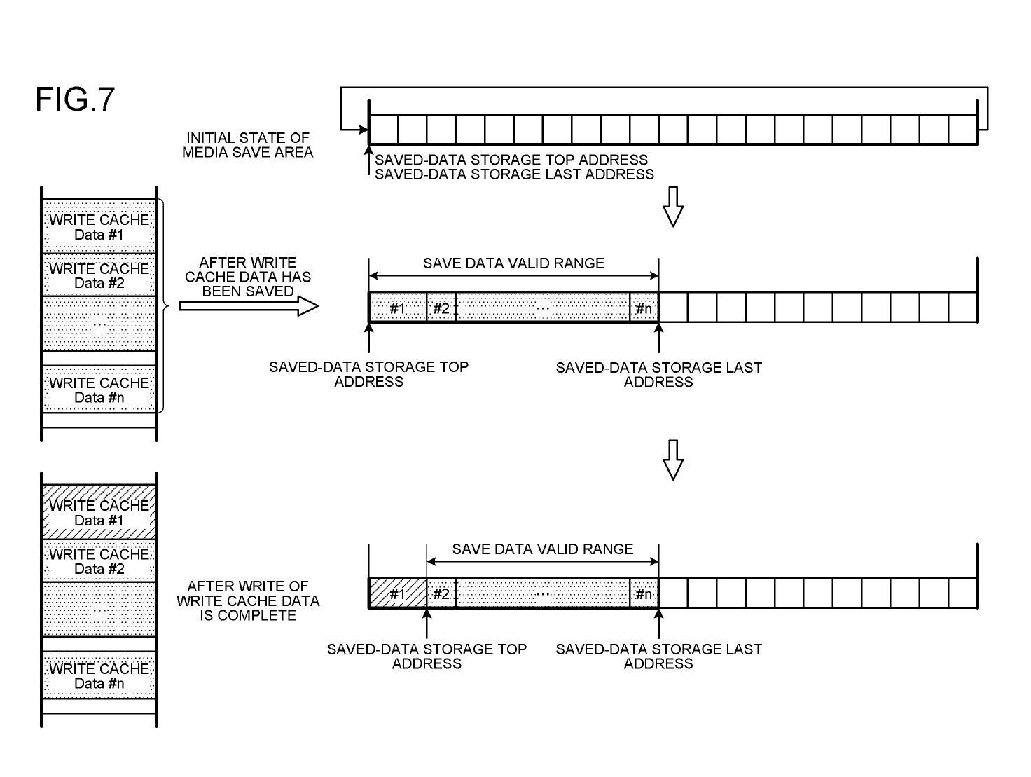

FIG. 7 is a diagram illustrating a saved-data storage top address and a saved-data storage last address in a media save area of disk media. In FIG. 7, the left side represents a state of the volatile memory 4 and the right side represents a state of the media save area 71 of the disk media 7. In the initial state of the media save area 71, that is, in the state where the write cache data has not been saved from the volatile memory 4, the saved-data storage top address and the saved-data storage last address become the same.

When write cache data #1 is saved from the volatile memory 4, the command processing unit 33 does not update the saved-data storage top address but updates the saved-data storage last address according to the data amount of the write cache data #1. Similarly, when write cache data up to write cache data #n have been saved from the volatile memory 4, the command processing unit 33 updates the saved-data storage last address according to the data amount of the pieces of write cache data #1 to #n, without updating the saved-data storage top address.

Thereafter, when the write cache data #1 is written in the user-data storage area 72 of the disk media 7 from the volatile memory 4, the write cache data becomes invalid. Therefore, when the saved-data storage top address matches with disk-media save destination address on the cache table, the command processing unit 33 updates the saved-data storage top address to an address where valid data of the write cache data is present. That is, as shown in FIG. 7, the saved-data storage top address becomes a top position of the write cache data #2. Subsequently, every time the write cache data is written in the user-data storage area 72 of the disk media 7 from the volatile memory 4, the command processing unit 33 updates the saved-data storage top address. When the pieces of write cache data #1 to #n have been written in the user data area of the disk media 7 from the volatile memory 4, the saved-data storage top address becomes the same as the saved-data storage last address and becomes the same state as the initial state.

A write operation to the disk media 7 is explained next.

In the write operation, the command processing unit 33 controls the disk control unit 6 to perform the write operation to write the write cache data in the user-data storage area 72 of the disk media 7 for the number of write commands set in the command information table 31. When the data indicated by the write command to be used for the write operation is stored as the write cache data in the volatile memory 4, the command processing unit 33 uses the data. Upon completion of the write operation, when the write cache data has not been saved in the disk media 7, the command processing unit 33 subtracts the written data size from the WC size. When the write cache data has been saved in the disk media 7, the command processing unit 33 updates the saved-data storage top address. Upon completion of the write operation to the user-data storage area 72 of the disk media 7, the command processing unit 33 invalidates the command information set in the command information table 31 and the cache control information set in the cache table in the cache control unit 34.

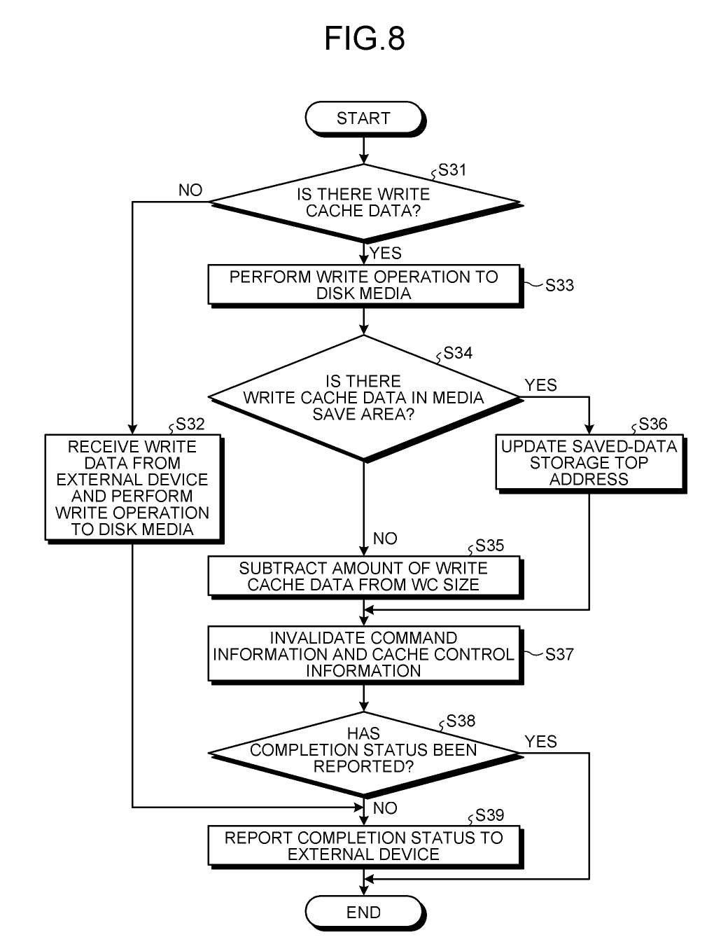

The operation of the magnetic disk drive 10 described above is explained with reference to a flowchart of FIG. 8. FIG. 8 is a flowchart illustrating a write operation to a disk media.

In the magnetic disk drive 10, when there is no write cache data writable to the disk media 7 (No at Step S31), the host IF control unit 1 receives write data from an external device and performs a write operation to the disk media 7 (Step S32), and reports a completion status to the external device (Step S39) to finish the process. In the magnetic disk drive 10, when there is write cache data writable to the disk media 7 (Yes at Step S31), the command processing unit 33 performs the write operation of the write data stored in the volatile memory 4 to the disk media 7 (Step S33).

Upon completion of the write operation by the command processing unit 33, when there is no write cache data in the media save area 71 of the disk media 7 (No at Step S34), the counter unit 2 subtracts the write cache data in the volatile memory 4, which has been written in the user-data storage area 72, from the WC size (Step S35). On the other hand, when the write cache data is in the media save area 71 of the disk media 7 (Yes at Step S34), the command processing unit 33 update the saved-data storage top address (Step S36).

The command processing unit 33 invalidates the command information in the command information table 31 and the cache control information set in the cache table corresponding to the target write cache data (Step S37).

When the completion status has been reported to the external device, the command processing unit 33 finishes the process (Yes at Step S38), and when the completion status has not been reported to the external device (No at Step S38), the command processing unit 33 performs control to report the completion status to the external device via the host IF control unit 1 (Step S39).

A saving process from the volatile memory 4 in the non-volatile memory 5 at the time of power shutdown in the magnetic disk drive 10 is explained next.

Upon detection of power shutdown from outside to the magnetic disk drive 10, the power-state detection unit 9 notifies the control unit 3 of the fact. Upon reception of the notification from the power-state detection unit 9, the data-save control unit 35 refers to the cache table in the cache control unit 34, to save unsaved write cache data in the volatile memory 4, which has not been saved in the media save area 71 of the disk media 7, in the non-volatile memory 5 using the backup power source 8. The data-save control unit 35 saves the information of the command information table 31 and the information of the cache table in the cache control unit 34 in the non-volatile memory 5, so that the command information and the cache control information can be reconstructed at the time of re-application of power. The data-save control unit 35 also adds header information or the like in order to determine whether the information saved in the non-volatile memory 5 is valid.

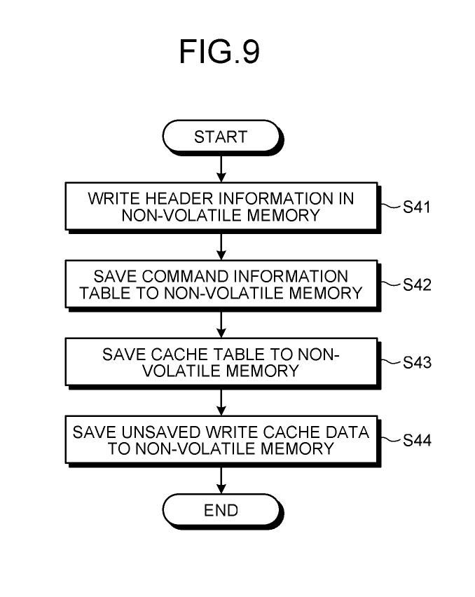

The operation of the magnetic disk drive 10 described above is explained with reference to a flowchart of FIG. 9. FIG. 9 is a flowchart illustrating a saving process from a volatile memory in a non-volatile memory.

In the power-state detection unit 9, when power shutdown from outside to the magnetic disk drive 10 is detected, the data-save control unit 35 writes header information in the non-volatile memory 5 using the backup power source 8 (Step S41), saves the command information table 31 in the non-volatile memory 5 (Step S42), saves the cache table in the cache control unit 34 in the non-volatile memory 5 (Step S43), and saves unsaved write cache data in the volatile memory 4, which has not been saved in the media save area 71 of the disk media 7, in the non-volatile memory 5 (Step S44).

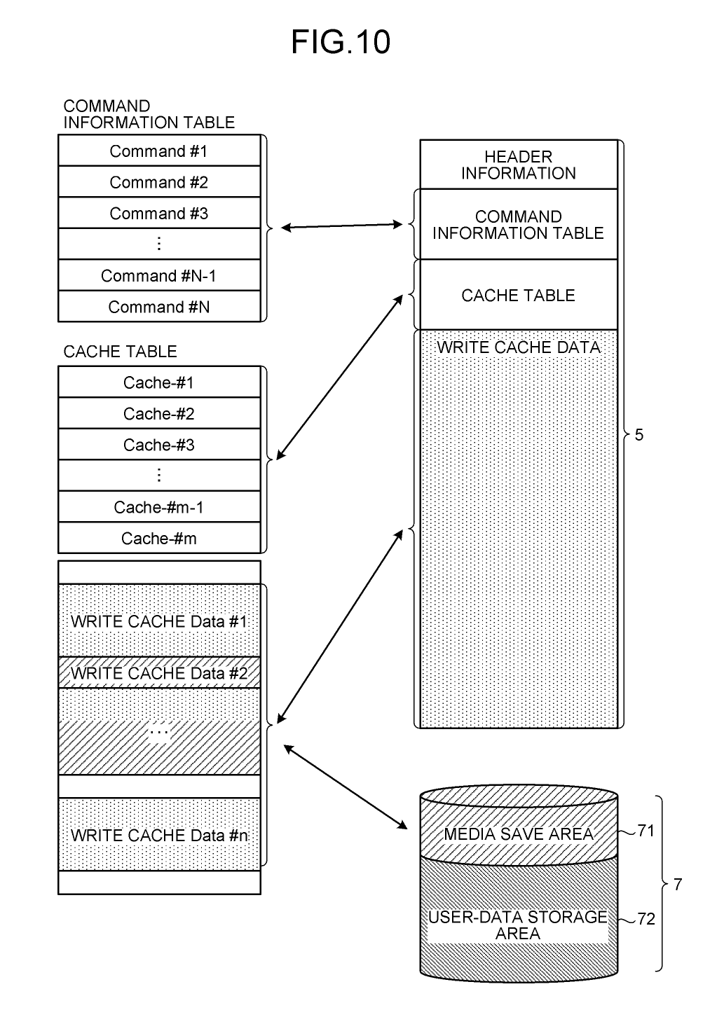

Respective pieces of data saved in the magnetic disk drive 10 in the above example are explained here. FIG. 10 is a diagram illustrating a movement of data in a magnetic disk drive. The unsaved write cache data in the volatile memory 4, which has not been saved in the media save area 71 of the disk media 7, is saved in the non-volatile memory 5, and the information of the command information table 31 and the information of the cache table in the cache control unit 34 are also saved in the non-volatile memory 5. In the non-volatile memory 5, header information is added to the saved data.

A restoring process of respective pieces of data from the non-volatile memory 5 at the time of re-application of power in the magnetic disk drive 10 is explained next.

When power is re-applied and the operation of the magnetic disk drive 10 becomes possible by power from the external power source, the power-state detection unit 9 notifies the control unit 3 of the fact. The data-save control unit 35 refers to the data saved in the non-volatile memory 5. When there is valid cache information, the data-save control unit 35 reconstructs the cache table in the cache control unit 34 and the command information table 31, and expands the write cache data to a storage state in the volatile memory 4 before the save. At this time, when there is write cache data saved in the disk media 7, the data-save control unit 35 also expands the write cache data saved in the disk media 7 to the storage state in the volatile memory 4 before the save. Accordingly, the magnetic disk drive 10 can restore the volatile memory 4 to the storage state equivalent to the storage state at the time of a decrease in power or power shutdown, and can ensure the write cache data.

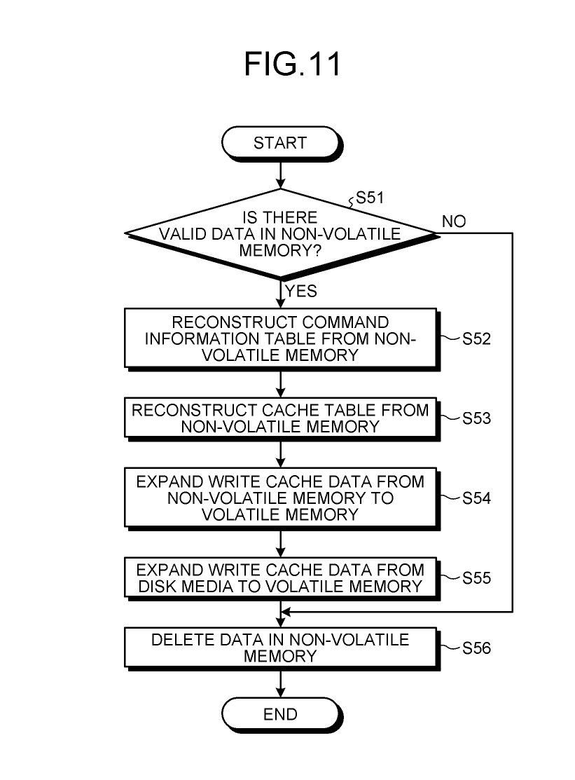

The operation of the magnetic disk drive 10 described above is explained with reference to a flowchart of FIG. 11. FIG. 11 is a flowchart illustrating a restoring process of respective pieces of data from a non-volatile memory at the time of re-application of power.

In the power-state detection unit 9, when re-application of power is detected, the data-save control unit 35 refers to whether there is valid data in the non-volatile memory 5. When there is valid data in the non-volatile memory 5 (Yes at Step S51), the data-save control unit 35 reconstructs the information of the command information table 31 stored in the non-volatile memory 5 in the command information table 31 (Step S52), and reconstructs the information of the cache table stored in the non-volatile memory 5 in the cache table in the cache control unit 34 (Step S53). The data-save control unit 35 expands the write cache data stored in the non-volatile memory 5 to the volatile memory 4 (Step S54), and expands the cache data stored in the media save area of the disk media 7 to the volatile memory 4 (Step S55). The data-save control unit 35 then deletes data in the non-volatile memory 5 to finish the process (Step S56).

At Step S51, the data-save control unit 35 refers to whether there is valid data in the non-volatile memory 5, and when there is no valid data (No at Step S51), deletes the data in the non-volatile memory 5 to finish the process (Step S56).

As explained above, according to the first embodiment, in the magnetic disk drive 10, when power supplied from outside is cut or decreased to a level at which an operation cannot be continued, the data-save control unit 35 saves the write cache data in the volatile memory 4 in the non-volatile memory 5 using the backup power source 8. At this time, when the WC size, which is the data amount in the volatile memory 4 that has not been saved in the disk media 7, exceeds the PLP backup data amount that can be saved in the non-volatile memory 5 when new write cache data is stored in the volatile memory 4, the command processing unit 33 saves the write cache data in the volatile memory 4, which has not been saved in the disk media 7, in the media save area 71 of the disk media 7. As a result, it is possible to obtain an effect that the magnetic disk drive 10 can maintain the WC size equal to or smaller than the PLP backup amount, and when power is cut or decreased to the level at which an operation cannot be continued, the magnetic disk drive 10 can save the write cache data in the volatile memory 4 in the non-volatile memory 5 safely and reliably.

### Second Embodiment

According to the first embodiment, in the magnetic disk drive 10, when the WC size exceeds the PLP backup data amount when new write cache data is stored in the volatile memory 4, the unsaved write cache data in the volatile memory 4 is saved in the media save area 71 of the disk media 7.

The command processing unit 33 can use a threshold for determining whether to save the unsaved write cache data in the volatile memory 4 in the media save area 71 of the disk media 7 and save the write cache data in the volatile memory 4 in the media save area 71 of the disk media 7 when the WC size exceeds the threshold.

In this manner, according to a second embodiment, in the magnetic disk drive 10, the command processing unit 33 uses the threshold, and when the WC size exceeds the threshold, saves the unsaved write cache data in the volatile memory 4 in the media save area 71 of the disk media 7. As a result, by setting a small threshold, although the number of performing the save of the unsaved write cache data in the volatile memory 4 in the media save area 71 of the disk media 7 increases, it is possible to obtain an effect that the magnetic disk drive 10 can have an effect that an operation can be performed in a state with a small WC size. Furthermore, by setting a large threshold, although an operation is performed in a state with a large WC size, it is possible to obtain an effect that the magnetic disk drive 10 can reduce the number of performing the save of the unsaved write cache data in the volatile memory 4 in the media save area 71 of the disk media 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk drive comprising:
a volatile memory;
a non-volatile memory;
a disk media memory;
a detection unit configured to detect a state of power supplied from outside;
a backup power source;
a data-save control unit configured to, when a decrease of power is detected by the detection unit, save data in the volatile memory to the non-volatile memory using the backup power source; and
a command processing unit configured to, when new data is stored in the volatile memory, when a data amount of unsaved data in the volatile memory, which has not been saved in the disk media memory, exceeds a backup data amount that can be saved from the volatile memory to the non-volatile memory, save the unsaved data to the disk media memory.

2. The disk drive according to claim 1, further comprising a task control unit configured to, when the data amount does not exceed the backup data amount even when the new data is stored in the volatile memory, store the new data to the volatile memory.

3. The disk drive according to claim 1, wherein the data-save control unit stores volatile memory information including information of a storage position of the data in the volatile memory, along with the data of the volatile memory to the non-volatile memory.

4. The disk drive according to claim 3, wherein the data-save control unit confirms the volatile memory information stored in the non-volatile memory after starting an operation by power supplied from outside, and expands data saved in the non-volatile memory and the disk media memory to a storage state in the volatile memory before saving, based on valid volatile memory information.

5. The disk drive according to claim 3, wherein the data-save control unit confirms the volatile memory information stored in the non-volatile memory after starting an operation by power supplied from outside, and expands data saved in the non-volatile memory to a storage state in the volatile memory before saving, based on valid volatile memory information.

6. The disk drive according to claim 1, wherein the command processing unit compares a threshold used for determining whether to save data in the volatile memory to the disk media memory with a data amount in the volatile memory, and when the data amount in the volatile memory exceeds the threshold, saves data in the volatile memory to the disk media memory.

7. A data saving method of a disk drive configured to save data in a volatile memory to a non-volatile memory using a backup power source, when power supplied from outside is decreased, the method comprising:
comparing a data amount of unsaved data which has not been saved in the disk media memory, in the volatile memory when new data is stored in the volatile memory with a backup data amount that can be saved from the volatile memory to the non-volatile memory; and
saving the unsaved data to the disk media memory, when the data amount of the unsaved data exceeds the backup data amount.

8. The method according to claim 7, wherein when the data amount does not exceed the backup data amount even when the new data is stored in the volatile memory, the new data is stored to the volatile memory.

9. The method according to claim 7, wherein volatile memory information including information of a storage position of the data in the volatile memory is stored along with the data of the volatile memory to the non-volatile memory.

10. The method according to claim 9, wherein the volatile memory information stored in the non-volatile memory is confirmed after starting an operation by power supplied from outside, and data saved in the non-volatile memory and the disk media memory is expanded to a storage state in the volatile memory before saving, based on valid volatile memory information.

11. The method according to claim 9, wherein the volatile memory information stored in the non-volatile memory is confirmed after starting an operation by power supplied from outside, and data saved in the non-volatile memory is expanded to a storage state in the volatile memory before saving, based on valid volatile memory information.

12. The method according to claim 7, wherein a threshold used for determining whether to save data in the volatile memory to the disk media memory is compared with a data amount in the volatile memory, and when the data amount in the volatile memory exceeds the threshold, data in the volatile memory is saved to the disk media memory.
